(19) United States
(12) Patent Application Publication
(10) Pub. No.: US 2005/0204903 A1
(43) Pub. Date: Sep. 22, 2005

(54) Apparatus and method for processing bell sound

(75) Inventors: Jae Hyuck Lee, Seoul (KR); Jung Min Song, Seoul (KR); Yong Chul Park, Seoul (KR); Jun Yup Lee, Yongin-si (KR)

Correspondence Address: JONATHAN Y. KANG, ESQ.;LEE, HONG, DEGERMAN, KANG & SCHMADEKA, 14th Floor, 801 S. Flgueroa Street, Los Angeles, CA, 90017, US

(73) Assignee: LG Electronics Inc.

(21) Appl. No.: 11/085,950

(22) Filed: Mar. 21, 2005

(30) Foreign Application Priority Data
Mar. 22, 2004 (KR) 10-2004-0019381

(51) Int. Cl. A63H 5/00; G10H 7/00; G04B 13/00

(52) U.S. Cl. 84/645

(57) ABSTRACT

Provided are an apparatus and a method for processing a bell sound in a wireless terminal capable of controlling a volume of sound source samples as the bell sound is played. According to the method, a plurality of notes, volume values, volume interval information, and note play times are extracted from inputted MIDI file. After the number of volume samples for each step is computed using the extracted volume value and the volume interval information, a volume of the sound source samples that correspond to a note that is to be played is controlled in advance using the number of the volume samples. Next, the sound source samples are converted using a frequency given to the notes and outputted, whereby a system load due to the real-time play of the bell sound can be reduced.

### BACKGROUND OF THE INVENTION

1. Field of the Invention

The present invention relates to an apparatus and a method for processing a bell sound, and more particularly, to an apparatus and a method for processing a bell sound capable of reducing system resources and outputting rich sound quality by controlling in advance a volume of sound sources before synthesizing a frequency.

2. Description of the Related Art

A wireless terminal is an apparatus for performing communication or transmitting/receiving data while moving. For the wireless terminal, there exist a cellular phone or a personal digital assistant (PDA).

In the meantime, a musical instrument digital interface (MIDI) is a standard protocol for data communication between electronic musical instruments. The MIDI is a standard specification for hardware and data structure that provide compatibility in the input/output between musical instruments or between musical instruments and computers through digital interface. Accordingly, the devices having the MIDI can share data because compatible data are created therein.

A MIDI file has information about intensity and tempo of a note, commands related to musical characteristics, and even a kind of an instrument as well as an actual score. However, unlike a wave file, the MIDI file does not store waveform information and so a file size thereof is relatively small and the MIDI file is easy to edit (adding and deleting an instrument).

At an early stage, an artificial sound was produced using a frequency modulation (FM) method to obtain an instrument's sound. That is, the FM method has an advantage of using a small amount of memory since a separate sound source is not used in realizing the instrument's sound using the frequency modulation. However, the FM method has a disadvantage of not being able to produce a natural sound close to an original sound.

Recently, as a price of a memory gets down, a method wherein sound sources for respective instruments and for each note of the respective instruments are separately produced and stored in a memory and a sound is produced by changing a frequency and an amplitude with an instrument's unique waveform maintained, has been developed. This method is called a wave-table type method. The wave-table type method has an advantage of producing a natural sound closest to an original sound, and thus is now widely used.

FIG. 1 is a view schematically illustrating a construction of a MIDI player of a related art.

As illustrated in FIG. 1, the MIDI player includes: a MIDI parser 110 for extracting a plurality of notes and note play times from a MID file; a MIDI sequencer 120 for sequentially outputting the extracted note play times; a wave table 130 in which at least more than one sound source sample is registered; an envelope generator 140 for generating an envelope so as to determine sizes of a volume and a pitch; and a frequency converter 150 for applying the envelope to the sound source sample registered in the wave table depending on the note play time and converting the envelope using a frequency given to the notes to output the same.

Here, the MIDI file can record information about music therein and include a score such as a plurality of notes, note play times, a timbre. The note is information representing a minimum unit of a sound, a play time is a length of each note, a scale is information about a note's height. For the scale, seven notes (e.g.: C, D, E and etc.) are generally used. The timbre represents a tone color and includes a note's unique characteristic of its own that distinguishes two notes having the same height, intensity, and length. For example, the timbre is a characteristic that distinguishes a note ‘C’ of the piano from a note ‘C’ of the violin.

Further, the note play time means a play time of each of the notes included in the MIDI file and is information about the same note's length. For example, if a play time of a note ‘D’ is ⅛ second, a sound source that corresponds to the note ‘D’ is played for ⅛ second.

Sound sources for respective instruments and for each note of the respective instruments are registered in the wave table 130. At this point, generally, the note includes steps of 1 to 128. There are limitations in registering all sound sources for the notes in the wave table 130. Accordingly, only sound source samples for representative several notes are registered in general.

The envelope generator 140 is an envelope of a sound waveform for determining sizes of a volume or a pitch of sound source samples played in response to the respective notes included in the MIDI file. Therefore, the envelope has a great influence on quality while using much resources of a central processing unit (CPU).

Here, the envelope includes an envelope for a volume and an envelope for a pitch. The envelope for the volume is roughly classified into four steps such as an attack, a decay, a sustain, and a release.

Since those four steps of time information for the sound source's volume are included in volume interval information, they are used in synthesizing a sound.

The frequency converter 150 reads a sound source sample for each note from the wave table 130 if a play time for a predetermined note is inputted, applies an envelope generated from the envelope generator 140 to the read sound source sample, and converting the envelope using a frequency given to the note to output the same. For the frequency converter 150, an oscillator can be used.

For example, in case the sound source sample registered in the wave table 130 is sampled with 20 KHz and a note of music is sampled with 40 KHz, the frequency converter 150 converts the sound source sample of 20 KHz into a sound source sample of 40 KHz to output the same.

Further, in case the sound source for each note does not exist on the wave table 130, a representative sound source sample for each note is read from the wave table 130, the read sound source sample is frequency-converted into a sound source sample that corresponds to each note. If a sound source for an arbitrary note exists on the wave table 130, the relevant sound source sample can be read and outputted from the wave table 130 from the wave table 130 without separate frequency conversion.

The above-described process is repeatedly performed whenever the play time for each note is inputted until a MIDI play is terminated.

However, the related art MIDI player sequentially performs processes of applying the envelope to the sound source sample and converting the envelope using the frequency that corresponds to each note. Accordingly, a system requires a considerable amount of operations and occupies much CPU resources. Further, the MIDI file should be played and outputted in real time. Since the frequency conversion is performed for each note as described above, music might not be played in real time.

Resultantly, since the related art MIDI player operates through the above-described process while using much CPU resources, it is difficult to realize rich sound quality without using a CPU of high performance. Therefore, a technology capable of guaranteeing a sound quality level sufficient for a user to hear while using a CPU of low performance is highly required.

### SUMMARY OF THE INVENTION

Accordingly, the present invention is directed to an apparatus and a method for processing a bell sound that substantially obviate one or more problems due to limitations and disadvantages of the related art.

An object of the present invention is to provide an apparatus and a method for processing a bell sound capable of reducing a system load generated by play of a bell sound.

Another object of the present invention is to provide an apparatus and a method for processing a bell sound capable of securing rich sound quality while reducing use amount of CPU resources.

A further another object of the present invention is to provide an apparatus and a method for processing a bell sound capable of reducing use amount of CPU resources due to frequency synthesis by controlling in advance a volume of sound sources before synthesizing a frequency.

A still further another object of the present invention to provide an apparatus and a method for processing a bell sound capable of controlling a volume of a sound source sample using a weight for the sound sample's volume and a volume weight.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an apparatus for processing a bell sound includes: a parser for performing a parsing so as to extract a plurality of notes, volume values, volume interval information, and note play times from an inputted MIDI file; a MIDI sequencer for sorting and outputting the parsed notes in a time order; a wave table in which a plurality of sound source samples are registered; a volume controller for controlling in advance a volume of sound source samples that correspond to the notes using the number of volume samples for each step in a volume interval of the respective notes; and a frequency converter for converting the volume-controlled sound source samples using a frequency given to each note outputted from the MIDI sequencer and outputting the same.

In another aspect of the present invention, there is provided a method for processing a bell sound, which includes: extracting a plurality of notes, volume values, volume interval information, and note play times from an inputted MIDI file; computing the number of volume samples for each step using the extracted volume values and the volume interval information; controlling a volume of sound source samples using the computed number of the volume samples for each step; and converting the controlled sound source samples using a frequency given to the notes.

The present invention controls in advance the volume of the sound source samples for a bell sound to be played and then performs frequency synthesis, thereby reducing a system load due to real-time play of the bell sound.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a related art MIDI player;

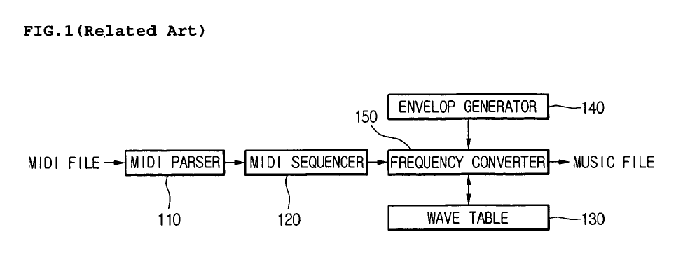

FIG. 2 is a block diagram of an apparatus for processing a bell sound according to an embodiment of the present invention;

FIG. 3 is a view illustrating an envelope for a volume interval of sound source samples; and

FIG. 4 is a view exemplarily illustrating that a volume of sound source samples is controlled in FIG. 2; and

FIG. 5 is a flowchart of a method for processing a bell sound according to an embodiment of the present invention.

### DETAILED DESCRIPTION OF THE INVENTION

Reference will now be made in detail to the preferred embodiments of the present invention, examples of which are illustrated in the accompanying drawings.

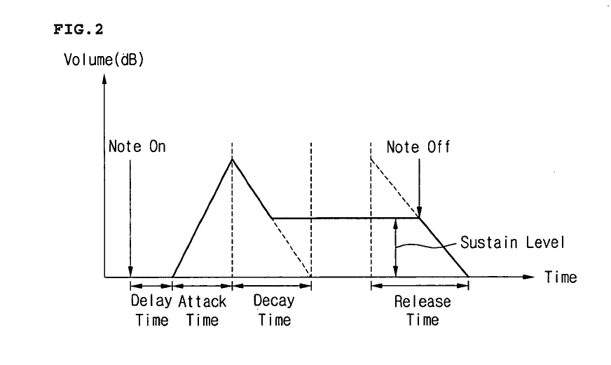

FIG. 2 is a schematic view illustrating a construction of an apparatus for processing a bell sound according to a preferred embodiment of the present invention.

Referring to FIG. 2, the apparatus for processing the bell sound includes: a MIDI parser 11 for extracting a plurality of notes, volume values, volume interval information, and note play times for the notes from a MIDI file; a MIDI sequencer 12 for sorting the note play times for the notes in a time order; a volume weight computation block 13 for computing a volume weight for each step using the extracted volume value; a sample computation block 14 for computing the number of volume samples for each step using the volume weight for each step and the volume interval information; a volume controller 15 for controlling a volume of sound source samples using the number of volume samples for each step; a frequency converter 16 for converting the controlled sound samples using a frequency given to the notes and outputting the same; and a wave table 18 in which the sound source samples are registered.

The above-described apparatus for processing a bell sound will be described in detail with reference to the accompanying drawings.

Referring to FIG. 2, the MIDI parser 11 parses the inputted MIDI file to extract a plurality of notes, volume values, volume interval information, and note play times for the notes.

Here, the MIDI file is a MIDI-based bell sound contents having score data. The MIDI file is stored within a terminal or downloaded from the outside through communication. The bell sound for the wireless terminal is mostly of a MIDI file except a basic original sound. The MIDI has a structure of having numerous notes and control signals for respective tracks. Accordingly, when each bell sound is played, an instrument that corresponds to each note and additional data related to the instrument are analyzed from the sound source samples, and a sound is produced and played using results thereof.

The volume interval information includes time information for an attack, a decay, a sustain, and a release. Since the volume interval information is differently represented depending on the notes, the volume interval information may be set so that it corresponds to each note.

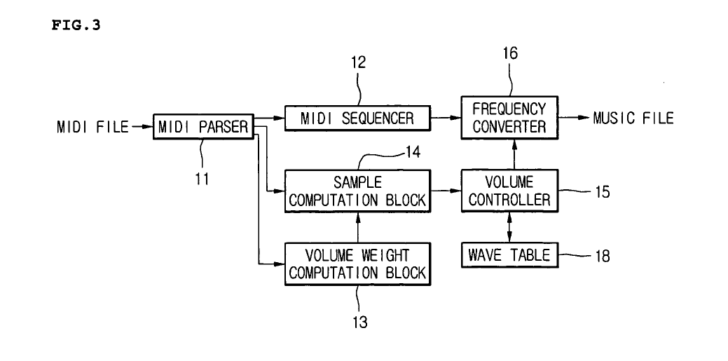

Specifically, referring to FIG. 3, an envelope for the volume is classified into four steps of an attack, a decay, a sustain, and a release. That is, a note can include an attack time during which the volume increases from zero to a maximum value for the note play time, a decay time during which the volume decreases from the maximum value to a predetermined volume, a sustain time during which the predetermined volume is sustained for a predetermined period of time, and a release time during which the volume decreases from the predetermined volume to zero and released. Since the above-described volume is so unnatural to realize an actual sound, a natural sound can be produced through a volume control. For that purpose, the envelope for the volume is controlled. In the present invention, the envelope is not controlled by the frequency converter but controlled in advance by a separate device.

Though the envelope is shown in a linear form, the envelope can be a linear form or a concave form depending on a kind of the envelope and characteristics of each step. Further, articulation data which is information representing unique characteristics of the sound source samples includes time information about the four steps of an attack, a decay, a sustain, and a release and is used in synthesizing a sound.

In the meantime, the MIDI file inputted to the MIDI parser 11 is a file containing in advance information for predetermined music and stored in a storage medium or downloaded in real time. The MIDI file can include a plurality of notes and note play times. The note is information representing a sound. For example, the note represents information such as ‘C’, ‘D’, and ‘E’. Since the note is not an actual sound, the note should be played using actual sound sources. Generally, the note can be prepared in a range from 1 to 128.

Further, the MIDI file can be a musical piece having a beginning and end of one song. The musical piece can include numerous notes and time lengths of respective notes. Therefore, the MIDI file can include information about the scale and the play time that correspond to the respective notes.

Further, predetermined sound source samples can be registered in the wave table 18 in advance. The sound source samples represent the notes for the sound sources closest to an original sound.

Generally, since the sound source samples registered in the wave table 18 are so insufficient as to produce all of the notes, the sound source samples are frequency-converted to produce all of the notes.

Accordingly, the sound source samples can be less than the notes. That is, there are limitations in making all of the 128 notes in form of the sound source samples and registering the sound samples in the wave table 18. Generally, only representative several sound source samples among the sound source samples for the 128 notes are registered in the wave table 18.

The MIDI file inputted to the MIDI parser 11 can include tens of notes or all of the 128 notes depending on a score. If the MIDI file is inputted, the MIDI parser 11 parses the MIDI parser to extract a plurality of notes, volume values, volume interval information, and note play times for the notes. Here, the note play time means a play time of each of the notes included in the MIDI file and is information about the same note's length.

For example, if a play time of a note ‘D’ is ⅛ second, a sound source that corresponds to the note ‘D’ is played for ⅛ second.

At this point, the notes and the note play times are inputted to the MIDI sequencer 12. The MIDI sequencer sorts the notes in an order of the note play time. That is, the MIDI sequencer 12 sorts the notes in a time order for the respective tracks or the respective instruments.

The parsed volume values are inputted to the volume weight computation block 13 and the volume interval information is inputted to the sample computation block 14.

The volume weight computation block 13 divides the inputted volume value into a plurality of steps between zero and one and applies a volume value for each step to the following equation 1 to compute the volume weight value.
Wev=(1−V)/log 10(1/V) [Equation 1]

where Wev (weight of envelope) is the volume weight for each step and represents an envelope-applied time weight, and V represents the volume value for each step.

Therefore, the volume weight for each step can be computed as many as the number of the steps divided from the volume value. For example, presuming that the volume value is divided into ten steps between zero and one, the volume value can be divided into total ten steps of 0.1, 0.2, . . . , 1. At this point, the dividing of the volume value into a plurality of steps should be optimized. That is, as the volume value is divided into more steps (e.g., more than ten steps), the volume is generated in a more natural manner but instead the CPU operation amount is increased as much as that. On the contrary, as the volume value is divided into the lesser steps (e.g., less than ten steps), the volume is not generated in a less natural manner. Therefore, it is preferable to divide the volume value into optimized steps with consideration of the CPU operation amount and the natural volume.

The volume weight for each step computed by the volume weight computation block 13 is inputted to the sample computation block 14. The sample computation block 14 computes the number of the volume samples using the volume weight for each step inputted from the volume weight computation block 13 and the volume interval information inputted from the MIDI parser 11.

The sample computation block 14 determines a final time for each volume interval that will be applied in the volume interval information using the volume weight for each step. The volume interval information contains time intervals set for the respective intervals currently determined, i.e., an attack time, a decay time, a sustain time, and a release time. At this point, the times for the respective volume intervals are newly determined by the volume weights for each step computed above, so that the final time for the respective volume intervals are determined.

Further, the numbers of the volume samples for each step in the respective volume interval where a final time has been determined are computed using the volume weight for each step. At this point, the number of the volume samples can be computed by the following equation 2.
Sev=Wev/(SR*Wnote*Td) [Equation 2]

where Sev (Sample of envelope) is the number of the volume samples for each step that corresponds to Wev,

Sev is a notion obtained by converting a time of second unit into the number of the samples,

Wev is a volume weight for each step, SR is a frequency of sound source samples,

Wnote is a weight representing a difference between a frequency of sound source samples and a frequency given to the notes, and

Td is a delay time when the volume value falls closely to zero.

That is, Sev is proportional to Wev and inverse-proportional to SR, Wnote, and Td. The Sev is obtained by diving Wev by a product SR*Wnote*Td.

Therefore, the numbers of the volume samples for each step (Sev) in the respective volume interval where the final time has been determined are computed using the equation 2. At this point, the computed number of the volume samples exists as many as the number of the steps of the volume values.

The number of the volume samples for each step (Sev) can be constructed in form of a table as provided by the following equation 3.
Table[Nvol]={Sev1, Sev2, Sev3, . . . , SevNvol} [Equation 3]

where Nvol represents the number of the steps of the volume value.

For example, presuming that the number of the steps of the volume value is ten, the table contains the number of the volume samples of ten in total. That is, the number of elements in the table is the same as the number of the steps of the volume.

The volume controller 15 controls a volume of the sound source samples using the number of the volume samples represented by the table.

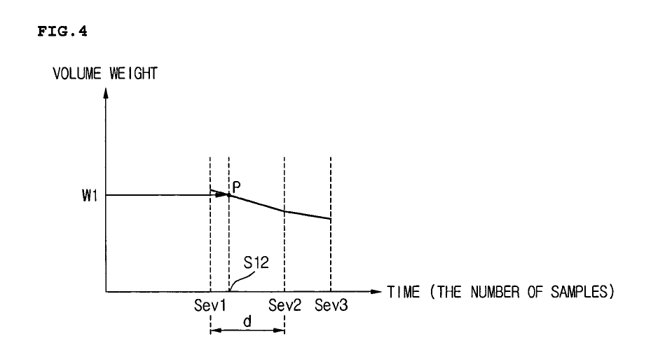

For example, referring to FIG. 4, if the envelope is to be applied to the volume of the sound source samples (b) between the number of first volume samples (Sev1) and the number of second volume samples (Sev2), the volume value of the sound source samples included between the number of the first volume samples (Sev1) and the number of the second volume samples (Sev2), a straight line having the number of the first volume samples (Sev1) and the number of the second volume samples (Sev2) for its both ends is made, a point P2 on the straight line that corresponds to a sample S12 is multiplied by a weight W1. By doing so, the volume of the sound source samples can be easily controlled. Accordingly, a volume value between zero and one for each step is multiplied by a current volume that is to be applied to an actual sound, so that final volume values that are to be multiplied by each sample are computed in advance.

In the meantime, the MIDI sequencer 12 receives a plurality of notes and note play times from the MIDI parser 11, and sequentially outputs the note play times for the notes to the frequency converter 16 after a predetermined period of time elapses.

The frequency converter 16 converts the sound source samples whose volumes have been controlled by the volume controller 15 using a frequency given to each of the notes outputted from the MIDI sequencer 12 and outputs a music file to the outside.

Though having been explained on the assumption of one note, a volume value and volume interval information for the note, and a note play time, the present invention can be applied in the same way to all of the notes included in the MIDI file in connection with the playing of the bell sound on the basis of the above case.

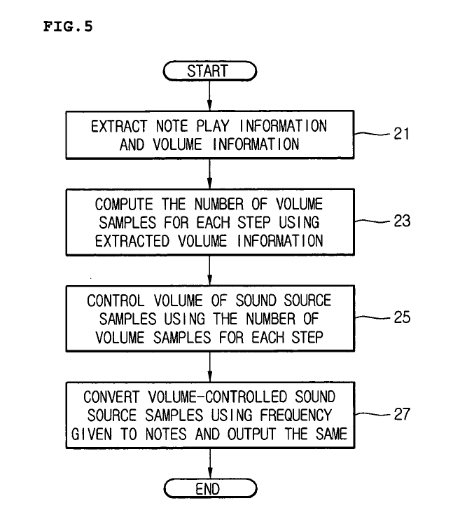

FIG. 5 is a flowchart of a method for processing a bell sound according to an embodiment of the present invention.

Referring to FIG. 5, note play information and volume information are extracted from the inputted MIDI file (S21). Here, the note play information includes a plurality of notes and play times for respective notes included in the MIDI file. The volume information includes a volume value of each note and the volume interval information.

After that, the number of volume samples for each step is computed using the extracted volume information (S23). For that purpose, the volume value included in the volume information is divided into optimized steps, and then the volume weight for each step is computed. Further, the final time for each volume interval is newly determined using the volume weight for each step, and the number of volume samples for each step in the respective volume interval is computed.

Next, a volume control of the volume of the sound source samples that correspond to the note play information is performed using the number of volume samples for each step (S25). After that, the sound source samples whose volumes have been controlled are converted using a frequency given to the notes and outputted (S27).

As described above, according to the present invention, the frequency converter does not control the volume. Instead, the volumes for the sound source samples are controlled in advance so that they may be appropriate for the respective notes and the frequency converter converts and outputs only the frequency of the sound source samples whose volumes have been controlled. According to the related art, congestion in operation amounts is generated and a CPU overload is thus caused as the frequency is converted and outputted in real time whenever loop data is repeated. The present invention can suppress the CPU overload and realize a MIDI play of more efficiency and high reliability.

It will be apparent to those skilled in the art that various modifications and variations can be made in the present invention. Thus, it is intended that the present invention covers the modifications and variations of this invention provided they come within the scope of the appended claims and their equivalents.

1. An apparatus for processing a bell sound comprising:
a parser for performing a parsing so as to extract a plurality of notes, volume values, volume interval information, and note play times from an inputted MIDI (musical instrument digital interface) file;
a MIDI sequencer for sorting and outputting the parsed notes in a time order;
a wave table in which a plurality of sound source samples are registered;
a volume controller for controlling in advance a volume of sound source samples that correspond to the notes using the number of volume samples for each step in a volume interval of the respective notes; and
a frequency converter for converting the volume-controlled sound source samples using a frequency given to each note outputted from the MIDI sequencer and outputting the same.

2. The apparatus according to claim 1, further comprising a sample computation block for computing the number of the volume samples for each step using the volume interval information extracted by the parser.

3. The apparatus according to claim 2, wherein the sample computation block uses the volume interval information and a volume weight for each step in order to compute the number of the volume samples for each step in the respective volume intervals.

4. The apparatus according to claim 3, wherein the volume weight for each step is computed by a volume weight computation block, and the volume weight computation block divides each volume value into a plurality of steps and computes a weight for a volume value for each step to deliver the computed weight to the sample computation block.

5. The apparatus according to claim 4, wherein the volume weight computation block divides each volume value into a plurality of steps in a range between zero and one.

6. The apparatus according to claim 4, wherein the volume weight for each step is an envelop-applied time weight.

7. The apparatus according to claim 3, wherein the volume interval information includes an attack time, a decay time, a sustain time, and a release time.

8. The apparatus according to claim 3, wherein the sample computation block reflects the volume weight for each step to determine times for each volume interval, respectively.

9. The apparatus according to claim 2, wherein the sample computation block computes the same number of the volume samples for each step as the number of steps of each volume value.

10. The apparatus according to claim 9, wherein the number of the volume samples for each step is proportional to the volume weight for each step and inverse-proportional to a frequency of the sound source samples, a difference between the frequency of the sound source samples and a frequency given to the notes, and a time at which the volume value falls to zero.

11. A method for processing a bell sound comprising:
extracting a plurality of notes, volume values, volume interval information, and note play times from an inputted MIDI (musical instrument digital interface) file;
computing the number of volume samples for each step using the extracted volume values and the volume interval information;
controlling a volume of sound source samples using the computed number of the volume samples for each step; and
converting the controlled sound source samples using a frequency given to the notes.

12. The method according to claim 11, wherein the volume interval information includes an attack time, a decay time, a sustain time, and a release time.

13. The method according to claim 11, wherein the computing of the number of volume samples comprises: computing a volume weight for each step using the extracted volume value and computing the number of volume samples for each step in each volume interval using the computed volume weight for each step.

14. The method according to claim 13, wherein a final time for each volume interval of the volume interval information is determined using the computed volume weight for each step.

15. The method according to claim 13, wherein the number of the volume samples for each step is converted in form of a table containing the number of samples in each volume interval and the volume of the sound source samples is controlled using the table.

16. The method according to claim 13, wherein the volume value is divided into a plurality of steps in an arbitrary range so as to compute the volume weight for each step and a weight for a volume value for each step is computed.

17. The method according to claim 16, wherein the volume value is divided into a plurality of steps in a range between zero to one.

18. The method according to claim 12, wherein the controlling of the volume of the sound source samples comprises: selecting a volume value for predetermined sound source samples existing in an interval between the two numbers of the volume samples, and giving a weight to the number of the volume samples of the sound source samples existing at a point on a straight line having the two numbers of the volume samples for its both end points.

19. The method according to claim 13, wherein the number of the volume samples is the same as the number of steps of each volume value.

20. The method according to claim 14, wherein the number of the volumes samples for each step is computed using an equation of Wev/(SR*Wnote*Td), where Wev is a volume weight for each step, SR is a frequency of sound source samples, Wnote is a difference between a frequency of sound source samples and a frequency given to the notes, and Td is a delay time until the volume value falls to zero.
